(19) United States
(12) Patent Application Publication
(10) Pub. No.: US 2006/0166700 A1
(43) Pub. Date: Jul. 27, 2006

(54) Electronic apparatus with antenna

(75) Inventors: Chu Chia Tsai, Taipei (TW); Chia Hsien Lee, Taipei (TW); Hung Yue Chang, Taipei (TW)

Correspondence Address: QUINTERO LAW OFFICE, 1617 BROADWAY, 3RD FLOOR, SANTA MONICA, CA, 90404, US

(73) Assignees: WISTRON CORP., TAIPEI HSIEN (TW); WISTRON NEWEB CORP., TAIPEI HSIEN (TW)

(21) Appl. No.: 11/179,693

(22) Filed: Jul. 11, 2005

(30) Foreign Application Priority Data
Jan. 27, 2005 (TW) TW94201519

(51) Int. Cl. H04B 1/38; H04M 1/00

(52) U.S. Cl. 455/557

(57) ABSTRACT

The invention relates to an electronic apparatus with an antenna apparatus. The antenna apparatus comprises an active antenna for receiving a radio frequency signal, a low noise amplifier for receiving the radio frequency signal from the active antenna and outputting a first signal, and a connection part for connecting to the electronic apparatus. The electronic apparatus comprises an interface port for connecting to the connection part, a processing module for receiving the first signal, and a power unit for providing power to the antenna apparatus by the interface port.

### BACKGROUND

The invention relates to an electronic apparatus and more particularly to a portable electronic apparatus with an antenna.

As the popularity of notebook computer increases, the demand for additional functionality, such as the ability to watch TV and broadcast audio, also increases. FIG. 1 is a schematic diagram illustrating a notebook computer 13 utilizing a TV box 12 for watching TV. A specific TV box 12, however, increases inconvenient as it must be carried with the notebook computer 13 and a transformer 11.

FIG. 2 is a schematic diagram illustrating a notebook computer having a built-in TV module and an antenna device for watching TV. A TV module 20 is built into the notebook computer 23 so that a TV signal can be received by an antenna 21. The TV signal reception quality is affected by the sensitivity of the antenna 21. If the antenna 21 is a passive antenna, the low sensitivity causes poor TV signals reception. If the antenna 21 is an active antenna, it increases the inconvenience as it requires an additional transformer, such as transformer 11 of FIG. 1.

### SUMMARY

The invention is generally directed to an electronic apparatus with an antenna apparatus.

According to one aspect of the invention, an electronic apparatus with an antenna apparatus is disclosed. The antenna apparatus comprises an active antenna for receiving a radio frequency signal, a low noise amplifier for receiving the radio frequency signal from the active antenna and outputting a first signal, and a connection part for connecting to the electronic apparatus. The electronic apparatus comprises an interface port for connecting to the connection part, a processing module for receiving the first signal and a power unit for providing power to the antenna apparatus via the interface port.

### DESCRIPTION OF THE DRAWINGS

The invention will be described by way of exemplary embodiments, but not limitations, illustrated in the accompanying drawings in which like references denote similar elements, and in which:

FIG. 1 is a schematic diagram illustrating a notebook computer employing a TV box.

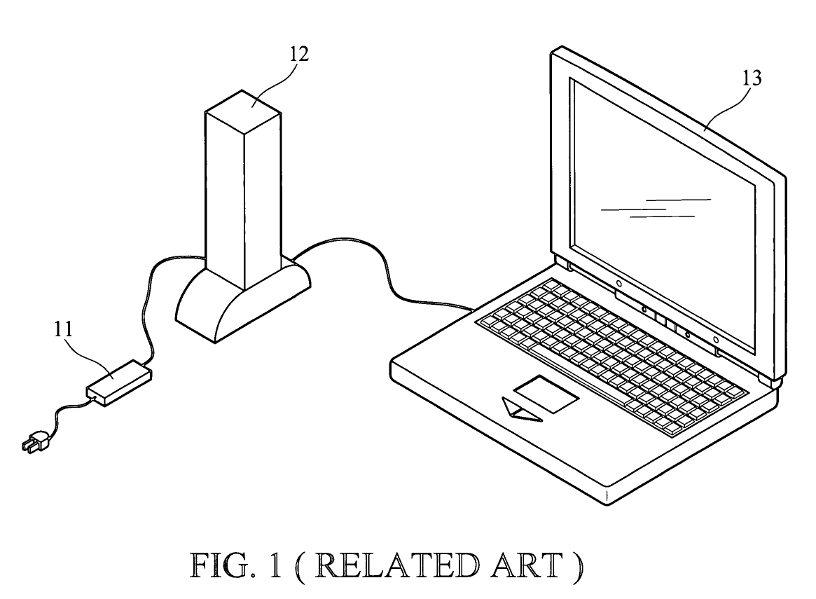

FIG. 2 is a schematic diagram illustrating a notebook computer having a built-in TV module with an antenna device for receiving a TV signal.

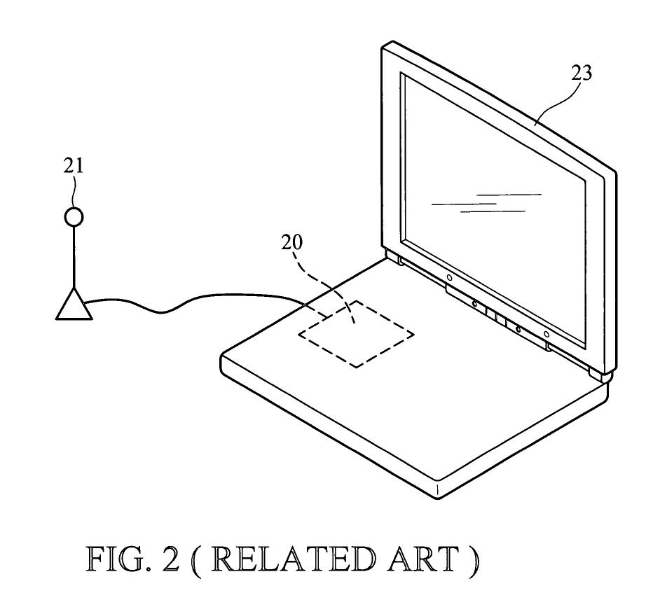

FIG. 3 is a schematic diagram of a notebook computer having an antenna device according to one aspect of the invention.

FIG. 4 is a schematic diagram of pin assignment of an interface port 34 and connection part 32 in FIG. 3.

FIG. 5 is a function block diagram of FIG. 3.

### DETAILED DESCRIPTION

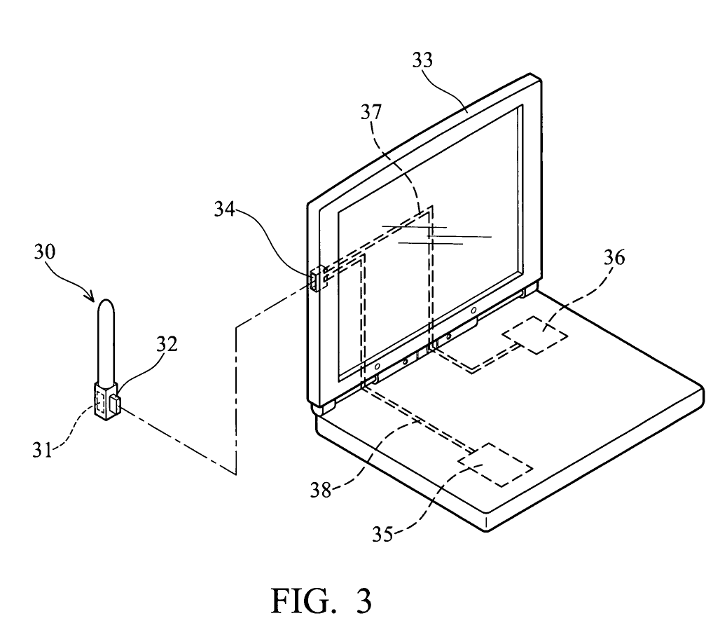

FIG. 3 is a schematic diagram of a notebook computer having an antenna device according to one aspect of the invention. Antenna device 30, comprising a low noise amplifier 31, connects to socket 34 (or called it “interface port”) disposed on notebook computer 33 by connection part 32. A power unit 36, built into the notebook computer 33, electrically connects to interface port 34 by a first signal cable 37 and provides power to antenna device 30 via the interface port 34. The first signal cable 37 comprises at least two signal lines for transmitting the power and ground. A processing module 35, built into the notebook computer 33, electrically connects to interface port 34 by a second signal cable 38 and receives signals from the antenna device 30. The second signal cable 38 comprises at least two signal lines for transmitting the signals from the antenna device 30 and ground. According to this embodiment, the antenna device 30 further comprises an active antenna unit (not shown in FIG. 3). When the antenna device 30 connects to the interface port 34 of the notebook computer 33 by connection part 32, the active antenna unit acts in response to the power provided by power unit 36, wherein the power unit 36 is provided by a south bridge of the notebook computer 33. When the active antenna unit receives radio frequency signals, the low noise amplifier 31 filters and amplifies the radio frequency signals to reduce the signal decay and outputs first signals to the processing module 35 via the second signal cable 38. According to another embodiment, the antenna device 30 further comprises at least two active antenna units to raise the quality of signal reception.

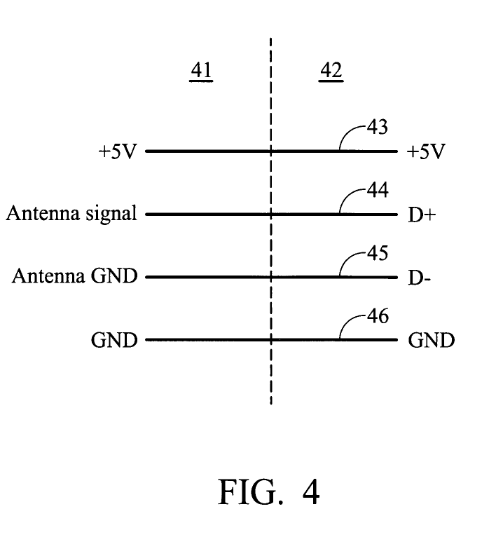

FIG. 3 illustrates an embodiment of the interface port 34 and processing module 35 with a USB socket and a Mini-PCI TV module. The USB socket has four signal lines connecting to THE USB host controller respectively representing +5V, GND, D+ and D−. In this embodiment, two signal lines representing +5V and GND are remain connected to the USB host controller and the other two signal lines are connected to processing module 35. Therefore, the interface port 34 suitable for the inventive antenna device only. FIG. 4 is a schematic diagram of pin assignment of interface port 34 and connection part 32 of FIG. 3, where 41 is the pin assignment of connection part 32 and 42 is the pin assignment of interface port 34. Pin 46 and Pin 43 connect to the USB host controller of the south bridge by a first signal cable 37. Pin 43 represents +5V in the connection part 32 and USB socket 34 for transmitting +5V power from the USB host controller of the south bridge. Pin 46 represents GND relative to +5V of USB host controller of south bridge in connection part 32 and USB socket 34. Pin 44 and Pin 45 electrically connect to Mini-PCI TV module 35 by a second signal cable 38 for transmitting antenna signal and antenna ground. Pin 44 represents antenna signal in connection part 32 and USB socket 34. Pin 45 represents antenna ground in connection part 32 and USB socket 34.

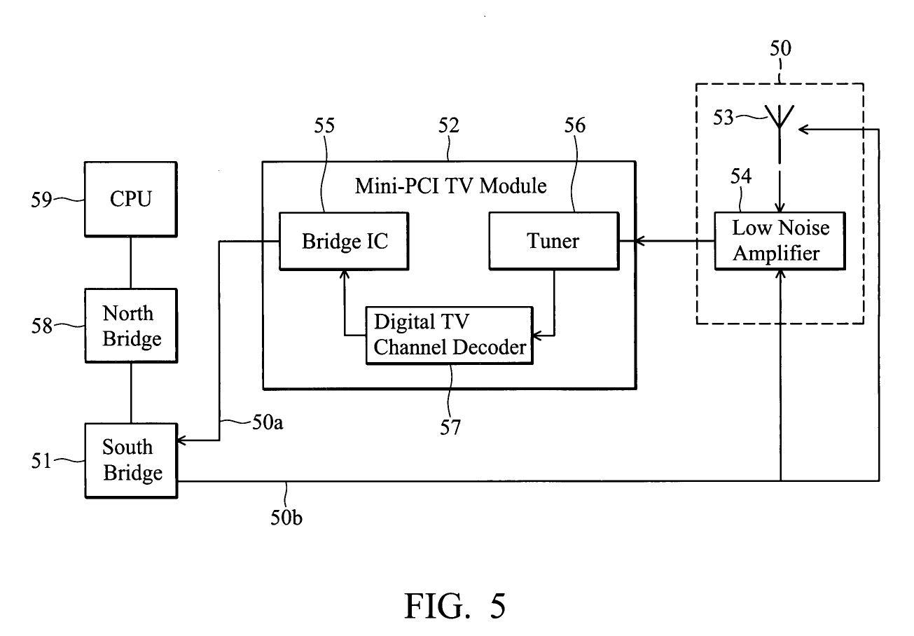

FIG. 5 is a function block diagram of FIG. 3. The low noise amplifier 54 of antenna device 50 acts in response to the power 50b provided by South Bridge 51 to receive the radio frequency signals from antenna unit 53 and output first signals. Mini-PCI TV module 52 comprises a tuner 56 for receiving first signals from the low noise amplifier 54, a digital TV channel decoder 57 electrically connected to the tuner 56 for receiving and decoding the first signal from the tuner 56 and outputting a data stream, and a bridge IC 55 electrically connected to the digital TV channel decoder 57 for transforming the data stream into PCI signals. South Bridge 51 processes PCI signals transmitted from Mini-PCI TV module 52 with North Bridge 58 and CPU 59 so that consumers can watch TV by the notebook computer.

The embodiment illustrated in FIG. 4 gives an electronic device with USB socket 34 for example, it is to be understood, however, that the invention is not limited thereto. The USB socket 34 can be substituted with any interface port, such as an IEEE 1394 socket or PS/2 socket among others. Furthermore, those skilled in the art can apply the present invention to PDAs, mobile phones or any other electronic device.

While the invention has been described by way of examples and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic apparatus with an antenna apparatus, comprising:
a main body;
an antenna apparatus, comprising:
an active antenna for receiving a radio frequency signal;
a low noise amplifier electrically connected to the active antenna for receiving the radio frequency signal from the active antenna and outputting a first signal; and
a connection part for connecting to the main body;
an interface port disposed on the main body for connecting to the connection part;
a processing module disposed inside the main body operable to receive the first signal via the interface port; and
a power unit disposed inside the main body for providing power to the antenna apparatus via the interface port.

2. The electronic apparatus of claim 1, wherein the processing module is a Mini-PCI television module, comprising:
a tuner for receiving the first signal;
a digital television channel decoder electrically connected to the tuner for receiving and decoding the first signal from the tuner and outputting a data stream; and
a bridge IC electrically connected to the digital television channel decoder for transforming the data stream into a PCI signal.

3. The electronic apparatus of claim 1, wherein the active antenna has one or a plurality of antenna units.

4. The electronic apparatus of claim 1, wherein the interface port is a USB socket and the connection part is a USB connector.

5. The electronic apparatus of claim 1, wherein the interface port is an IEEE 1394 socket and the connection part is an IEEE 1394 connector.

6. The electronic apparatus of claim 1, wherein the power unit is provided by a south bridge.

7. The electronic apparatus of claim 1, wherein the apparatus further comprises a first signal cable and a second signal cable, wherein the first cable is coupled between the interface port and the processing module and the second signal cable is coupled between the interface port and the power unit.

8. The electronic apparatus of claim 7, wherein the first signal cable comprises at least two signal lines for transmitting the first signal and ground.

9. The electronic apparatus of claim 7, wherein the second signal comprises at least two signal lines for transmitting the power provided by the power unit and ground.
